(19) United States
(12) Patent Application Publication
(10) Pub. No.: US 2023/0395836 A1
(43) Pub. Date: Dec. 7, 2023

(54) INCREASING ION CONDUCTIVITY OF SOLID ELECTROLYTE MATERIALS THROUGH STRUCTURAL DISORDER

(71) Applicant: Board of Trustees of Western Michigan University, Kalamazoo, MI (US)

(72) Inventors: Robert Allen Makin, III, Kalamazoo, MI (US); Steven Michael Durbin, Kalamazoo, MI (US)

(21) Appl. No.: 18/205,059

(22) Filed: Jun. 2, 2023

Related U.S. Application Data
(60) Provisional application No. 63/348,291, filed on Jun. 2, 2022.

(51) Int. Cl. H01M 8/1069; H01M 8/1253; H01M 8/103; H01M 8/1067

(52) U.S. Cl. CPC H01M 8/1069; H01M 8/1253; H01M 8/103; H01M 8/1067; H01M 2008/1293

(57) ABSTRACT

Some aspects of the present invention may include a method of fabricating an electrolyte suitable for a fuel cell or electrolyzer, comprising: determining one or more or two or more target material properties of the electrolyte or overall or overall system-level property of the fuel cell or electrolyzer; utilizing a predefined quantitative relationship between a material property and an order parameter involving one or more electrolyte components to determine at least one material ordering that has the target material property; and controlling process parameters to form at least one electrolyte material having the target material property. Some aspects of the present invention may include a method of fabricating an electrolyte suitable for a fuel cell or electrolyzer, to determine at least one or more material orderings that that provides the best overall performance for the device.

### CROSS REFERENCE TO RELATED APPLICATIONS

The present application claims the benefit under 35 USC § 119(e) to U.S. Provisional Patent Application No. 63/348,291, filed Jun. 2, 2022; the entire disclosure of the prior application is incorporated herein by reference.

### TECHNICAL FIELD

The present disclosure relates to systems and methods that may be utilized to assess and adjust the ion conductivity and operating temperatures of electrolytes in fuel cells and other applications such as electrolyzers.

### BACKGROUND OF THE INVENTION

Fuel cells provide an environmentally clean and highly efficient method to convert the chemical energy of fuels to electrical energy. Their basic structure consists of a negative electrode (anode) and positive electrode (cathode) on either side of an electrolyte. Fuel (hydrogen in the case of a hydrogen fuel cell) is fed to the anode and air is fed to the cathode. At the anode the fuel is separated into positive charges and electrons. The electrons are used as electricity in external circuits, while the protons move through the electrolyte where they unite with oxygen and the electrons to produce water and heat. When hydrogen is used as the fuel, the end products are only electricity, water and heat.

In solid oxide fuel cells (SOFCs), the electrolyte material is a heavy metal ceramic oxide, and the fuel cell usually operates at high temperatures close to 1000° C. (1,830° F.). This elevated operation temperature removes the need for precious metal catalysts but may result in a slow start-up time and may necessitate thermal shielding to protect users/operators. Additionally, high temperature operation requires that the electrolyte material have a high durability to continuously operate in such an environment. The need for high elevated temperatures stems from the ion conductivity of the solid oxides, which at lower temperatures become resistive to the flow of oxygen ions, preventing the cell from functioning efficiently. At an operating temperature of 500° C. (932° F.), catalysts are required but they do not need to be precious metals, thus keeping costs low while reducing the strain on the material and mitigating issues surrounding heat shielding. One of the current challenges is to identify a suitable oxide material for the electrolyte that will have high ion conductivity at lower temperatures (500° C. vs 1000° C.).

In other applications, fuel cells using polymer electrolyte membrane (PEM) as electrolytic systems can be used at much lower temperatures than solid oxide fuel cells (around or below the boiling point of water) and operate at high current densities. They are subject to lowered efficiencies due to electrical resistance of the electrolyte and gas diffusion of oxygen and hydrogen across the membrane, among others, and active investigation is also underway to improve their efficiency and durability.

Further, electrolyzers are similar to fuel cells except the energy-releasing reaction is reversed to form hydrogen gas from the breakdown of water, requiring energy input to do so. Improved oxide electrolyte materials may thus also increase the efficiency of such reactions, requiring less energy input to generate hydrogen gas, which can then be used as input for fuel cells or other uses.

Improvements in electrolyte properties for fuel cells and electrolyzers can made through change of the ordered structure of the electrolyte materials themselves. For example, through the analysis of Raman spectra, electron microscopy images, or x-ray diffraction plots, the order parameter of a sample can be measured. This order parameter is directly proportional to key material properties. In the case of heavy-metal oxides used in SOFCs such as zirconium oxide or yttria-stabilized zirconia, a material property that can be controlled by the degree of disorder in the sample is oxygen ion conductivity, providing a means of increasing the ion conductivity of a given material by controlling its degree of disorder. Similar advances can be made through examining and impacting the order parameter of polymer components of PEMs.

Embodiments and aspects of the present disclosure describe methods of obtaining an order parameter (S or S²) in fuel cell electrolyte materials and using this parameter to design and build improved fuel cell solid electrolytes. Similarly, another embodiment is to use the method for tuning S for electrolyte materials in electrolyzers, which are used to generate hydrogen gas.

In some embodiments, the order can be tuned to affect two or more properties of the electrolyte or to optimize fuel cell or electrolyzer device function for a set of properties.

These and other features, advantages, and objects of the present invention will be further understood and appreciated by those skilled in the art by reference to the following specification, claims, and appended drawings.

### BRIEF SUMMARY OF THE INVENTION

Some aspects of the present invention may include a method of fabricating an electrolyte suitable for a fuel cell or electrolyzer, comprising: determining a target material property of the electrolyte or overall or overall system-level property of the fuel cell or electrolyzer; utilizing a predefined quantitative relationship between a material property and an order parameter involving one or more electrolyte components to determine at least one material ordering that has the target material property; and controlling process parameters to form at least one electrolyte material having the target material property.

In other aspects, the quantitative relationship can be expressed as a linear relationship between the material property and order parameter S or S².

In yet other aspects, the electrolyte is a solid oxide or a polymer.

In yet other aspects, the material property is ion conductivity, or oxygen ion conductivity.

In other aspects, the process parameters are controlled such that the order parameter is changed for the electrolyte material. In others, the stoichiometry of the components of the electrolyte material remains substantially constant.

In still other aspects of the present disclosure, the order parameter S or S² is assessed via one or more of electron diffraction, Raman spectroscopy, Rutherford backscattering and electron microscopy. In others, the order parameter is controlled via controlling the growth parameters of the electrolyte. In others, the order parameter is controlled via exposure to radiation.

In other aspects, the solid oxide comprises yttria-stabilized zirconia. In others, the solid oxide comprises ZrO₂. In others, the electrolyte comprises polybenzimidazole.

In yet other aspects, the electrolyte is fabricated for use in a fuel cell. In others, an electrolyzer. In other aspects, the target property is ion conductivity at a temperature at or lower than about 800° C.

Some aspects of the present invention may also include a method of fabricating an electrolyte suitable for fuel cell or electrolyzer device comprising: determining two or more target material properties of the electrolyte or overall system-level property of the device; utilizing a predefined quantitative relationship between each material or system-level property and an order parameter to determine at least one optimal ordering that provides the best overall performance for the device; and controlling process parameters to form the electrolyte material and device having the targeted ordering and optimally determined performance.

Some aspects of the present invention may also include a method of selecting an electrolyte suitable for fuel cell or electrolyzer device comprising: determining one or more target material properties of the electrolyte or overall system-level property of the device; utilizing a predefined quantitative relationship between the one or material/system-level property and an order parameter to determine at least one optimal ordering that provides the best overall performance for the device. In some aspects, two or more target material properties of the electrolyte or overall system-level property of the device are determined.

Other features and advantages of the present invention will become apparent from the following detailed description, including the drawings. It should be understood, however, that the detailed description and the specific examples, while indicating preferred embodiments, are provided for illustration only, because various changes and modifications within the spirit and scope of the invention will become apparent to those skilled in the art from the detailed description.

### BRIEF DESCRIPTION OF THE DRAWINGS

The present invention(s) are illustrated by way of example and not limitation with reference to the accompanying drawings, in which like references generally indicate similar elements or features.

FIG. 1 is a schematic of a hydrogen fuel cell.

FIGS. 2(a)-2(c) show three example lattices of a ternary material with two cations (black and white circles) and one anion (white squares) wherein the cation sublattice undergoes disorder; grey circles represent a cation that has a 50% probability of being a black cation and a 50% probability of being a white cation. FIG. 2(a) is a fully ordered lattice with S=1; FIG. 2(b) has an intermediate degree of disorder; and FIG. 2 (c) is completely disordered (S=0).

FIGS. 3(a)-3(c) show experimental results demonstrating a linear relationship between a given material property and the degree of disorder (measured by S²) within the material. FIG. 3(a) shows trends in band gap of various stoichiometries of ZnSnN² with increasing S² (inset is a plot of the band gap versus temperature for the three films of Zn_{0.62} Sn_{0.38}N with a negative band gap), 3(b) ZnO band gap as function of S², and 3(c) the particle removal efficacy of polybenzimidazole (PBI) filters as function of the degree of disorder in their polymer fibers.

FIGS. 4(a)-4(c) show ion conductivity of yttria stabilized zirconium (YSZ) and ZrO₂ as a function of the degree of disorder (S²); (a) shows the ion conductivity versus S² of YSZ for 3, 8 and 10 mol. % yttrium YSZ at 1000° C.; (b) shows the ion conductivity versus S² of 8 mol % YSZ at 800° C.; (c) shows the ion conductivity versus S² of ZrO₂ (i.e., where the material contains 0% yttrium) for varying degrees of order at 750° C.

FIG. 5 shows the variation of degree of disorder in a sample of ZrO₂ at increasing levels of exposure to radiation using a 27 MeV Xe9+ ion beam.

### DETAILED DESCRIPTION

There are different types of fuel cells depending on the materials used in the constituent components of the fuel cell. Typically, the types of fuel cells are distinguished by the material used as the electrolyte material. Examples of known fuel cells include polymer electrolyte membrane (PEM) fuel cells, direct methanol fuel cells, phosphoric acid fuel cells, alkaline fuel cells, molten carbonate fuel cells and solid oxide fuel cells.

In solid oxide fuel cells (SOFCs), the electrolyte material is a heavy metal ceramic oxide, and the fuel cell usually operates at high temperatures close to 1000° C. (1,830° F.). This elevated operation temperature removes the need for precious metal catalysts but may result in a slow start-up time and may necessitate thermal shielding to protect users/operators. Additionally, high temperature operation requires that the electrolyte material have a high durability to continuously operate in such an environment. The need for high elevated temperatures stems from the ion conductivity of the solid oxides, which at lower temperatures become resistive to the flow of oxygen ions such that the resistance prevents the cell from functioning efficiently. At an operating temperature of 500° C. (932° F.), catalysts are required but they do not need to be precious metals, thus keeping the cost low while reducing the strain on the material and mitigate issues surrounding heat shielding. One of the current challenges is to identify a suitable oxide material for the electrolyte that will have high ion conductivity at lower temperatures (500° C. vs 1000° C.).

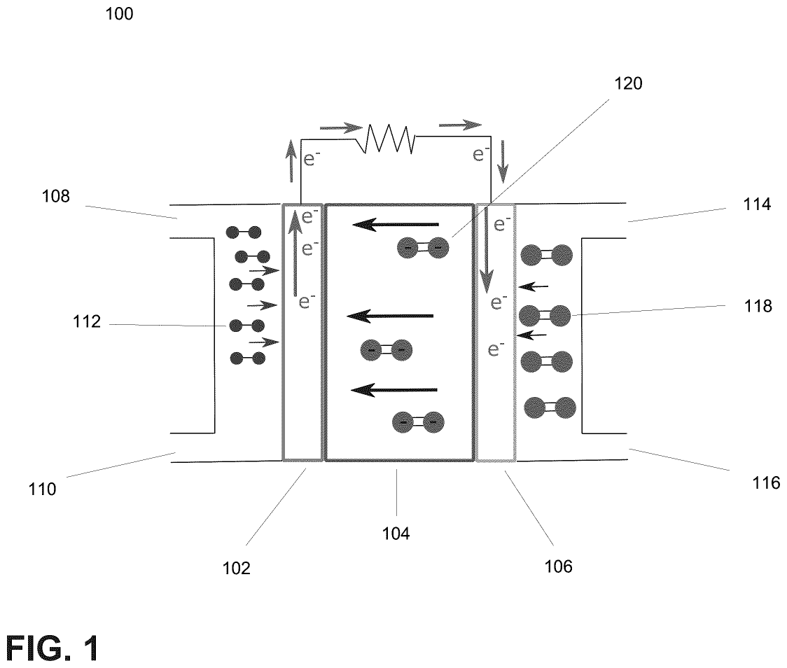

FIG. 1 is a schematic of a hydrogen fuel cell 100, showing the constituent parts of the fuel cell and connection to external circuit that the fuel cell is powering. Anode 102 and cathode 106 are selectively separated by electrolyte 104. Hydrogen (H₂) 112 is input at 108 and unused hydrogen is output at 110. In this application, oxygen (O₂) 118 is input at 114 and unused oxygen is output at 118. At certain temperatures and conditions the electrolyte 104 is selectively permeable to oxygen ions 120, which spatially decouples the oxidation reaction of hydrogen and oxygen and allows electron flow between the cathode 106 and anode 102, which generates a current that can be used for other uses, like powering a car's drivetrain, for instance. Byproducts in general consist only of waste heat and water.

Electrolyzers, being a similar technology, most often use PEM, alkaline, or solid oxide electrolytes. They tend to run at lower temperatures (i.e., less than 90-100° C.) to avoid the water feedstock turning into steam, except in the case of solid oxide electrolytes, which need high temperatures comparable to fuel cells to operate. As electrolyzers require energy input, both to provide electrical current to drive the reaction and power the controller systems, and to heat and/or potentially cool the system (depending on the electrolyte system chosen), considerable scope exists to fine-tune electrolyte materials for such desirable properties as efficiency and durability.

A defining feature of crystalline materials is a structure composed of periodic arrangements of atoms. Describing crystalline structures by their periodicity provides a powerful framework for understanding the properties of these types of materials. However, this approach to these materials begins to break down when the periodic structure of the material is disrupted by disorder, i.e., when atoms are swapped from their expected sites as defined by the periodic pattern, which results in interesting phenomena within crystalline materials with varying degrees of disorder.

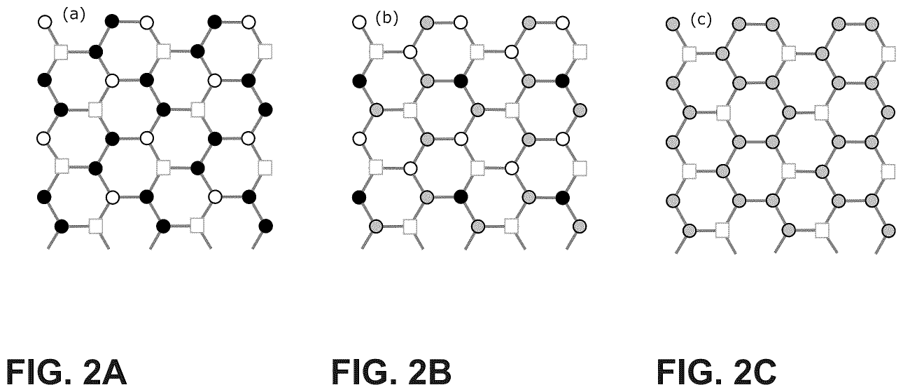

In order to determine the effect of disorder on the properties of crystalline materials, it is beneficial to quantify the degree of disorder within a material. The amount of disorder in any crystalline lattice may be described by a single parameter (order parameter S), which ranges in value from unity (corresponding to perfect ordering as seen in FIG. 2a) to zero (corresponding to complete randomization as seen in FIG. 2c). Elucidating FIGS. 2(a)-2(c) further, they show three example lattices of a ternary material with two cations (white and black circles) and one anion (white squares) wherein the cation sublattice undergoes disorder. Grey circles represent a cation that has a 50% probability of being a black cation and a 50% probability of being a white cation. Thus, the lattice shown in FIG. 2 is a fully ordered lattice with S=1, the lattice shown in FIG. 2 (b) has an intermediate degree of disorder, and the lattice of FIG. 2 (c) is completely disordered (S=0). Quantifying crystalline disorder within a Bragg-Williams type framework may elucidate the reported variations in ion conductivity of solid oxide electrolytes.

The S value (or S² value) of a sample may be determined using a variety of techniques, including electron diffraction (e.g., performed in-situ in a laboratory during actual crystal growth), Raman spectroscopy, and electron microscopy. S and S² in general are interchangeable. S² tends to better model a linear relationship between a system property and disorder goes as S². However, S (as it is not squared) can go negative and can be used to see relationships that may not follow a linear trend with S².

Historically for disordered structures, theoretical calculations of bulk material properties may be difficult due to the very large number of atoms that must be included in order to properly simulate the complexities introduced by disorder. However, it is possible to describe the material in terms of the different nearest neighbor environments that can occur when disorder is introduced to the system. With this description, along with the application of the Ising model and a focus on pair-wise interactions, a bulk property P of the material can be expressed as:

P(x,S)=S²[P(0.5,1)−P(x,0)]+P(x,0) (1)

where S is the order parameter and x represents the composition, and permits consideration of non-stoichiometric compounds, i.e., compounds having different ratios of the constituent atoms. Hence, with a minimum number of calculated and/or experimental points in conjunction with Eq. (1) it is possible to fully determine the range of accessible property values.

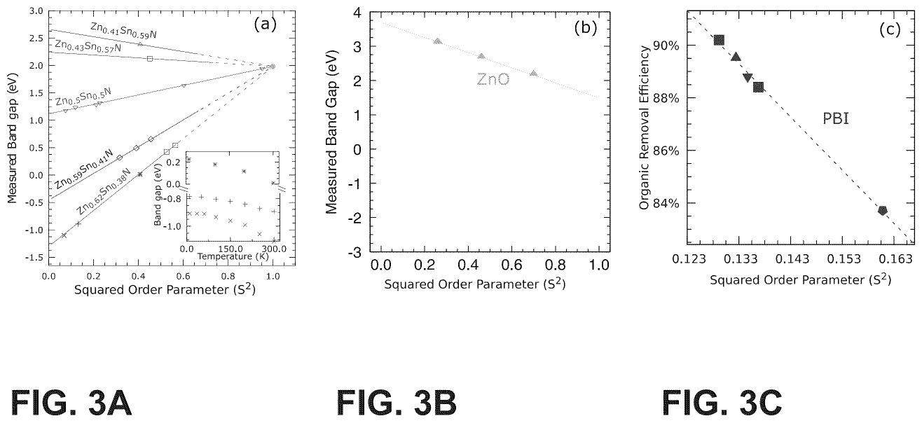

This formula has been verified experimentally for a number of different materials and system-level properties. FIGS. 3(a)-3(c) show experimental results that demonstrate a linear relationship between a given material property and the degree of disorder (measured by S²) within the material. Furthermore, with these samples it is possible to control the degree of disorder in a lattice by systematically tuning (varying) the growth conditions of the samples, such that it is possible to sweep a wide range of values for the bandgap within a single material system.

For semiconductors, it has been shown that the system-level property can be the energy band gap (Eg) of semiconductors, as shown in FIG. 3a and FIG. 3b by the linear relationships between Eg and S² for two different semiconductor materials: various stoichiometries of ZnSnN₂, and ZnO. Inset in FIG. 3(a) is a plot of the band gap versus temperature for the three Zn_{0.62} Sn_{0.38}N films with a negative band gap, showing a decreasing band gap with increasing temperature, the sign of a negative band gap.

The approach has also been applied to other materials, such as polymers (e.g., polypropylene) wherein a system level property that has a linear relationship with S² is the filtration efficiency of mask filters made of polymers as shown in FIG. 3(c), as the particle removal efficacy of polybenzimidazole (FBI) filters decreases as function of the degree of disorder in the polymer fibers. FBI filters are a type of PEM also used in fuel cells and electrolyzers and ion conductivity may be affected by disorder in some applications.

Equation (1) is also believed to apply to ionic conductivity in solid electrolyte oxides used in SOFCs, i.e.,

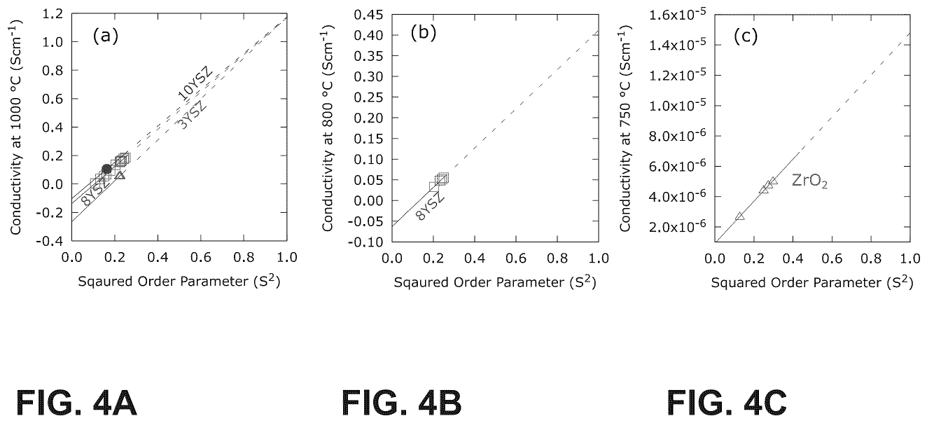

σ(x,S)=S²[σ(0.5,1)−σ(x,0)]+σ(x,0) (2)

where σ is the ionic conductivity of the material. Based on data from the literature, FIGS. 4(a)-4(c) show the ion conductivity of yittria-stabilized zirconia (YSZ) and ZrO₂ as a function of the degree of disorder (S²). Currently, one of the most widely used electrolytes in SOFCs is YSZ. At 1000° C., the ionic conductivity of 10 mol. % YSZ (10YSZ), 8 mol. % YSZ (8YSZ), and 3 mol. % YSZ (3YSZ) increases with increasing order in the lattice structure, as shown in FIG. 4a. This holds true for lower temperatures as well, as shown in FIG. 4b, with the ion conductivity increasing at 800° C. with decreasing disorder for 8 mol % YSZ. The same trend holds true for ZrO₂, at 750° C. as shown in FIG. 4c, which is typically not known to be a good conductor of oxygen ions. However, its ion conductivity increases with increasing order.

A number of other materials outside of those depicted in FIG. 4 have been investigated, including multicomponent oxides composed of four or more different types of atoms, which may be used in SOFCs. In the context of crystalline disorder studies, as the number of different types of constituent atoms is increased, the complexity of the nearest neighbor environments of atoms in the structure is also increased.

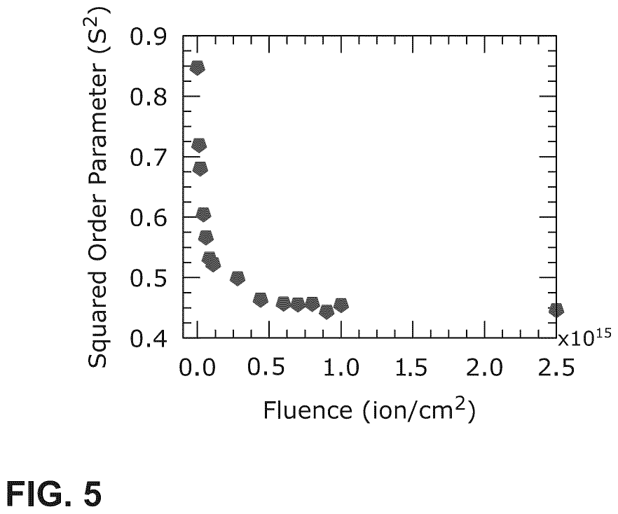

The binary oxide ZrO₂, the base component used in several currently used compound oxide electrolytes, is an example of a suitable compound. FIG. 5 shows the variation of degree of disorder in a sample of ZrO₂ at increasing levels of exposure to radiation (measured in ions/cm²) to a 27 MeV Xe⁹⁺ ion beam.

Compositions of ZrO₂ and other materials beyond reported nominally stoichiometric compositions may be utilized to determine the relationship between ion conductivity and the order parameters of the material. For ZrO₂, a range of Zr-rich to O-rich compositions may be utilized. This may be accomplished using a thermal evaporation system having an oxygen plasma source that produces active oxygen for growth of crystalline materials, and an electron beam source, which is utilized to evaporate Zr. The deposition system may have a high-temperature (>1000° C.) substrate heater, multiple substrate capability (thin films may be deposited on a surface/substrate for mechanical support), and an in-situ electron diffraction system (a low current diagnostic tool not capable of evaporating the material), which enables not only real-time measurement of the order parameter, but also deposition rate.

The order parameter measurements may be benchmarked on selected films using Raman spectroscopy and/or electron microscopy. Composition of the thin films may be determined using Rutherford backscattering spectrometry, and measurements of ion conductivity may be performed using a suitable conductivity measurement system and furnace. Also, although it is possible to achieve a wide range of S² values via molecular-beam epitaxy (MBE), since it is a kinetic, non-equilibrium growth process, other growth techniques may be limited in the range of S² values that they can achieve. Thus, it may be desirable to have means outside of growth methods to adjust the S² values of samples. For ZrO², this can be done via irradiation of the sample via an ion beam, as demonstrated by the plot in FIG. 5. Thus, suitable ion beam facilities may be used to investigate the impact of irradiation on S² values of samples.

In order to synthesize oxygen-based crystals, a radio frequency plasma source may be utilized to generate active oxygen species. The electron beam evaporation source may be used for generating zirconium vapor directed towards a substrate, which may comprise crystalline quartz (SiO₂). Although substrate temperature is a growth parameter for various compounds, tuning (varying) the energy and percentages of various active and neutral species within the plasma may have a greater (easily controllable) effect on the order parameter of the materials. Variations may be achieved by varying the applied gas flow rate into this source, the geometry of the aperture plate, and the gas mixture including the introduction of inert gases such as argon.

Measurement of the order parameters may be accomplished in-situ using a suitable high-energy electron diffraction system in glancing angle geometry so as not to interfere with the deposition process. It has been observed with other crystalline systems that it is possible to pause growth in some instances, adjust one or more process parameters, and continue growing with a different order parameter. In general, it may be possible to detect compositional variations from within a Rutherford backscattering spectrometry measurement (at least approximately). “Course grid” parameter variational sweeps for each material composition may be performed using, for example, a minimum of 5 compositions (two on either side of 1:1). Approximately 25 separate growth experiments may therefore provide useful data.

The relative fluxes of materials such as Zr and activated oxygen may provide an estimate of the composition of the films. However, other factors such as the sticking coefficient of the zirconium and oxygen or temperature of the substrate may also influence the composition of the film. Rutherford backscattering spectrometry may be utilized to determine the composition of the material. The material compositions may then be related back to the corresponding growth conditions for each field whereby a mapping of growth parameters to resulting film compositions can be created.

The oxygen ion conductivity of the samples may also be measured. A conductivity measurement system along with a furnace in which the samples can be heated may be utilized to take conductivity measurements at a range of temperatures from room temperature up to, for example, 1500° C. The conductivity may be measured at intervals (e.g., at 50° C.) from room temperature up to 700° C. This data may be utilized to determine the relationships between S (or S²) and the ionic conductivity for various materials such as ZrO₂ (e.g., FIG. 4c).

From this course grid of trend lines, trends in ionic conductivity can be determined as the composition changes (e.g., from Zr-rich to O-rich), and subsequently determine the optimal composition and degree of disorder to obtain samples with the highest values of the ionic conductivity for temperatures of interest (e.g., between 500° C. and 700° C.) and grow and measure the ionic conductivity of a set of films around these optimal compositions and degrees of disorder.

Once the desired composition and S 2 value for a material (e.g., ZrO₂) have been determined to achieve the desired ionic conductivity, additional samples (e.g., films) may be grown in order to determine the impact of irradiation of the samples on the degree of disorder of the films. For example, a film with an initially high value of S² and at a selected composition of Zr:O of 1:1 may be exposed to increased levels of radiation from an ion beam, and the S² value may be measured at set intervals of radiation dosage. This experiment may be repeated for different compositions to determine if composition changes the rate at which irradiation changes the degree of disorder within the sample. The impact of irradiating the samples with ions may also be evaluated to determine if the type of ion used changes the impact on the change of the degree of disorder within the film. Also, the optimal ions to use and amount of radiation exposure to use to in order to obtain the optimal S² value for achieving the highest ionic conductivity in ZrO₂ may also be determined.

Referring again to FIG. 4, this basic methodology presents new ways to increase the ion conductivity of materials used as solid electrolytes. FIG. 4 demonstrates this for yttria-stabilized zirconia (YSZ); as disorder decreases within YSZ the oxygen ion conductivity increases. Additionally, the composition can be tuned along with disorder to increase the range of property values accessible for the material. For YSZ, FIG. 4 shows that with increasing yttria composition and increasing disorder will lead to higher ion conductivities. FIG. 4c shows that a similar result holds for ZrO₂. The degree of order within a sample may also be controlled by irradiating the sample. FIG. 5 shows that by controlling the irradiation fluence the degree of ordering can be tuned (controlled).

Another embodiment of the present invention is to use the method for tuning S for electrolyte materials in electrolyzers, which are used to generate hydrogen gas.

The above description is considered that of the illustrated embodiments only. Modifications of the processes, materials, and structures will occur to those skilled in the art. Therefore, it is understood that the embodiments shown in the drawings and described above are merely for illustrative purposes and not intended to limit the scope of the method, which is defined by the following claims as interpreted according to the principles of patent law, including the Doctrine of Equivalents.

What is claimed is:

1. A method of fabricating an electrolyte suitable for a fuel cell or electrolyzer, comprising:
determining a target material property of the electrolyte or overall or overall system-level property of the fuel cell or electrolyzer;
utilizing a predefined quantitative relationship between a material property and an order parameter involving one or more electrolyte components to determine at least one material ordering that has the target material property; and
controlling process parameters to form at least one electrolyte material having the target material property.

2. The method of claim 1, wherein the quantitative relationship can be expressed as a linear relationship between the material property and order parameter S or S².

3. The method of claim 1, wherein the electrolyte is a solid oxide.

4. The method of claim 1, wherein the electrolyte is a polymer.

5. The method of claim 1, wherein the material property is ion conductivity.

6. The method of claim 5, wherein the ion conductivity is oxygen ion conductivity.

7. The method of claim 1, wherein the process parameters are controlled such that the order parameter is changed for the electrolyte material.

8. The method of claim 7, wherein the stoichiometry of the components of the electrolyte material remains substantially constant.

9. The method of claim 2, wherein the order parameter S or S² is assessed via one or more of electron diffraction, Raman spectroscopy, Rutherford backscattering and electron microscopy.

10. The method of claim 7, wherein the order parameter is controlled via controlling the growth parameters of the electrolyte.

11. The method of claim 7, wherein the order parameter is controlled via exposure to radiation.

12. The method of claim 3, where the solid oxide comprises yttria-stabilized zirconia.

13. The method of claim 3, where the solid oxide comprises ZrO₂.

14. The method of claim 4, where the electrolyte comprises polybenzimidazole.

15. The method of claim 1, where the electrolyte is fabricated for use in a fuel cell.

16. The method of claim 1, where the electrolyte is fabricated for use in a electrolyzer.

17. The method of claim 1, where the target property is ion conductivity at a temperature at or lower than about 800° C.

18. A method of fabricating an electrolyte suitable for fuel cell or electrolyzer device comprising:
determining two or more target material properties of the electrolyte or overall system-level property of the device;
utilizing a predefined quantitative relationship between each material or system-level property and an order parameter to determine at least one optimal ordering that provides the best overall performance for the device;
and controlling process parameters to form the electrolyte material and device having the targeted ordering and optimally determined performance.

19. A method of selecting an electrolyte suitable for fuel cell or electrolyzer device comprising:
determining one or more target material properties of the electrolyte or overall system-level property of the device;
utilizing a predefined quantitative relationship between the one or material/system-level property and an order parameter to determine at least one optimal ordering that provides the best overall performance for the device.

20. The method of claim 19, wherein two or more target material properties of the electrolyte or overall system-level property of the device are determined.
